(19) United States
(12) Patent Application Publication
(10) Pub. No.: US 2026/0216729 A1
(43) Pub. Date: Jul. 30, 2026

(54) 3D MICROFLUIDIC DEVICE AND METHOD OF SEPARATING PARTICLES BY SIZE FROM A SUSPENSION

(71) Applicant: University of Kentucky Research Foundation, Lexington, KY (US)

(72) Inventor: Guigen Zhang, Lexington, KY (US)

(21) Appl. No.: 19/145,270

(22) PCT Filed: Jan. 5, 2024
(86) PCT No.: PCT/US24/10576

§ 371 Date: Jul. 2, 2025

Related U.S. Application Data
(60) Provisional application No. 63/478,720, filed on Jan. 6, 2023.

(51) Int. Cl. B01L 3/00

(52) U.S. Cl. CPC B01L 3/502761; B01L 2200/0652; B01L 2300/0864; B01L 2300/088

(57) ABSTRACT

A microfluidic device includes a flow channel including (a) an inlet, (b) an inlet section, extending along a first tangent, (c) an intermediate spiral section, (d) an outlet section, extending along a second tangent, and (e) a three-dimensional outlet system including a plurality of outlets. The flow channel has a rectangular cross section having a height H and a width W, where H>W. The device is useful in a method for stable alignment, focusing, fractionation and separation of conventional particles as well as bioparticles (cells and vesicles) from a suspension.

### RELATED APPLICATIONS

This application claims priority to U.S. Provisional Patent Application Ser. No. 63/478,720, filed on Jan. 6, 2023, and U.S. Provisional Patent Application Ser. No. 63/478,727, filed on Jan. 6, 2023, both of which are hereby incorporated by reference.

### TECHNICAL FIELD

This document relates to a new and improved three-dimensional (3D) microfluidic device and related method for separating particles by size from a suspension sample. The 3D device and method advantageously provide stable alignment, focusing, fractionation and separation of conventional particles as well as bioparticles (cells and vesicles) with high precision and certainty.

### BACKGROUND

Although inertial-based microfluidics have been researched for years for particle separation and fractionation, most of these inertial-focusing-based microfluidic channels take the design with a horizontal-oriented cross-section (i.e., a cross-section that is greater in width than height). To obtain a high flowrate, these channels sometime are made as wide as 500 μm or more to provide a large cross-section area. This horizontal orientation inadvertently introduces difficulties for inertial focusing to work, because in such wider channels, the focusing positions are difficult to reach, adding uncertainty in particle separation and fractionation applications. Although multiple inlets with differential flowrates have been utilized to address some of the problems, to date wide adaptation of microfluidic technologies has not occurred because these devices require real-time monitoring and tuning using a microscope to function properly.

This document relates to 3D microfluidic devices with a vertical orientation (i.e., a cross-section that is greater in height than width), an intermediate spiral section and a plurality of discrete outlets that function together to allow for sorting, fractionation and separation of conventional particles and biological particles, such as cells and vesicles, from a suspension. Advantageously, the device and method also provide an unprecedented tunable gating and bracketing capability without requiring any real-time monitoring and tuning under a microscope. For example, when the device and method are used to isolate circulating tumor cells (CTCs) in blood samples, such bracketing capability will aid the distinction of CTCs from other white blood cells, as well as differentiation between vital and non-vital CTCs.

### SUMMARY

In accordance with the purposes and benefits set forth herein, a new and improved 3D microfluidic device is provided comprising, consisting of or consisting essentially of a flow channel including (a) an inlet, (b) an inlet section, extending along a first tangent, (c) an intermediate spiral section, (d) an outlet section, extending along a second tangent, and (e) a 3D outlet system including a plurality of outlets.

In at least some embodiments of the microfluidic device, the flow channel has a rectangular cross section having a height H and a width W, where H>W.

The flow channel may be formed by four walls—a first sidewall, a second sidewall, a top wall and a bottom wall. The outlet system may include four outlets, including an upper outlet bordering the top wall, a lower outlet bordering the bottom wall, and sandwiched in between, a center left outlet bordering the first sidewall, and a center right outlet bordering the second sidewall. The cross-section areas of the upper and lower outlets typically are of the same size, and that of the center left and right outlets are of the same size, with the former a few times larger than the latter. The flow channel may have a width of between about 1 μm and about 250 μm and an aspect ratio of channel cross sectional area (H/W) of from about 1.5 to about 4.5. The intermediate spiral section may include about 2 to about 10 complete loops.

More specifically, the intermediate spiral section may include a plurality of consecutive half-circle loops wherein the second innermost half-circle loop has a radius that is about 0.2 mm to about to about 20 mm. The subsequent half-circle loops going outwards incrementally increase in radius by from about 2.5 W to about 5.0 W. The innermost half-circle loop may have a radius smaller than that of the second innermost half-circle loop.

In at least some embodiments, the cross sectional area of the flow channel at the outlet section is partitioned into four sub-channels leading to four outlets including an upper outlet, a lower outlet, and sandwiched in between a left center outlet and a right center outlet with their cross-section area in a set of ratios of 0.4:0.4:0.1:0.1. In some embodiments, the upper outlet is W wide and 0.4 H high and the lower outlet is W wide and 0.4 H high, the center left outlet is 0.5 W wide and 0.2 H high and the center right outlet is 0.5 W wide and 0.2 H

In accordance with an additional aspect, a microfluidic device comprises, consists of or consists essentially of a flow channel including (a) an inlet, (b) an inlet section, extending along a first tangent, (c) an intermediate spiral section, (d) an outlet section, extending along a second tangent, and (e) a 3D outlet system including a plurality of outlets including an upper outlet, a lower outlet and, sandwiched between the upper and lower outlets, a center left outlet and a center right outlet whereby particles in a suspension passing through the flow channel are separated for recovery of different size particles through the (i) upper and lower outlets, (ii) the center left outlet and (iii) the center right outlet. A flow-rate ratio in the flow channel at the intermediate spiral section to that at the center left outlet and the center right outlet, the upper outlet and the lower outlet is about 1:0.1:0.1:0.4:0.4.

In accordance with yet another aspect, a method of separating particles by size from a suspension sample, comprises, consists of, or consists essentially of: (a) introducing the suspension sample into the inlet of a flow channel and (b) flowing the sample suspension through the flow channel from the inlet serially through (i) an inlet section, extending along a first tangent, (ii) an intermediate spiral section, (iii) an outlet section, extending along a second tangent, and (iv) a 3D outlet system including a center left outlet, a center right outlet, an upper outlet and a lower outlet wherein particles of a first size pass through the upper and lower outlets, particles of a second size pass through the center left outlet and particles of a third size pass through the center right outlet.

The method may further include using a flow channel having a rectangular cross section with a height H and a width W, wherein H>W and adjusting the height H, the width W or the height H and the width W of the flow channel to tune separation of different size particles through the center left outlet, the center right outlet, the upper outlet and the lower outlet. The method may further include adjusting a radius of the innermost loop of the intermediate spiral section to tune separation of different size particles through the center left outlet, the center right outlet, the upper outlet and the lower outlet.

The method may further include adjusting radii of a plurality of loops of the intermediate spiral section to tune separation of different size particles through the center left outlet, the center right outlet, the upper outlet and the lower outlet.

The method may further include adjusting an overall number of a plurality of loops of the intermediate spiral section to tune separation of different size particles through the center left outlet, the center right outlet, the upper outlet and the lower outlet.

The method may further include adjusting overall length of one or more of the inlet section, the intermediate spiral section and the outlet section of the flow channel to tune separation of different size particles through the center left outlet, the center right outlet, the upper outlet and the lower outlet.

The method may further include adjusting at least one of the flow velocity of the suspension through the flow channel, the viscosity of the suspension, and the density of the suspension to tune separation of different size particles through the center left outlet, the center right outlet, the upper outlet and the lower outlet. The method may also include adjusting flow velocity of the suspension through the flow channel by changing the pressure or using carrying solutions with different densities or viscosities.

In the following description, there are shown and described several different embodiments of the new and improved microfluidic device and method for providing stable alignment, focusing, fractionation and separation of conventional particles as well as bioparticles (cells and vesicles) with high precision and certainty. As it should be realized, the device and method are capable of other, different embodiments and their several details are capable of modification in various, obvious aspects all without departing from the device and method as set forth and described in the following claims. Accordingly, the descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the device and method and together with the description serve to explain certain principles thereof. A person of ordinary skill in the art will readily recognize from the following discussion that alternative embodiments of the device and method may be employed without departing from the principles described below.

FIG. 1 is a perspective view of one possible embodiment of the 3D microfluidic device including a single inlet, an intermediate spiral section and a plurality of outlets, where the upper and lower outlets may be merged into one for easy sidewall implementation.

FIG. 2A illustrates how large particles initially align along a virtual wall about 0.25 W from the inner sidewall of the flow channel as they get closer to the outlet passing through the intermediate spiral section.

FIG. 2B illustrates how the large particles then move toward their stable, focusing positions F₁ and F₂

FIG. 2C illustrates how the smaller particles tend to circle in a helical pattern in the upper and lower parts of the flow channel as the suspension sample passes through the intermediate spiral section.

FIG. 3 is a detailed cross sectional view of the channel at the outlet section when it is partitioned into four sub-channels leading to four outlets including the upper outlet, the lower outlet, and sandwiched in between, the center left outlet and the center right outlet.

FIG. 4A is a top plan view of another embodiment of the microfluidic device adapted to separate particles of different sizes from a suspension of those particles wherein 10 μm particles are discharged from the upper and lower outlets, 15 μm particles are discharged from the center right outlet and 18-20 μm particles are discharged from the center left outlet.

FIG. 4B is a detailed perspective view of the outlets of the device illustrated in FIG. 4A.

FIG. 5A is a top plan view of yet another embodiment of the microfluidic device adapted to separate particles of different sizes from a suspension of those particles wherein 10 μm particles are discharged from the upper and lower outlets, 15-18 μm particles are discharged from the center right outlet and 20 μm particles are discharged from the center left outlet.

FIG. 5B is a detailed perspective view of the outlets of the device illustrated in FIG. 5A.

Reference will now be made in detail to the present preferred embodiments of the device and method.

### DETAILED DESCRIPTION

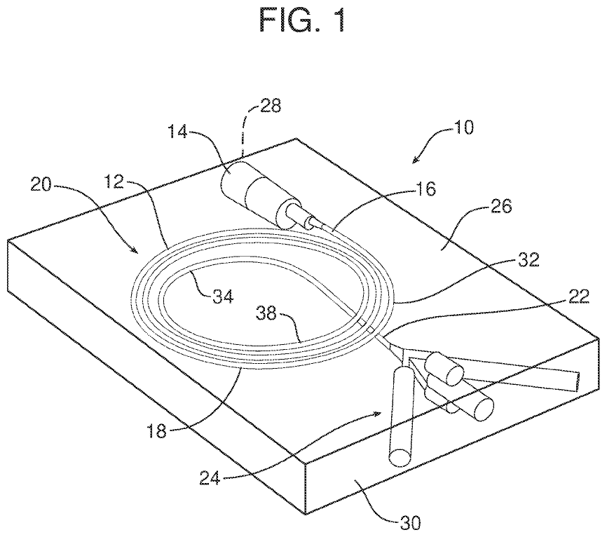

Reference is now made to FIGS. 1-3 which illustrate one possible embodiment of the new and improved microfluidic device 10 adapted for stable alignment, focusing, fractionation and separation of conventional particles, including bioparticles (cells and vesicles) with high precision and certainty.

As illustrated, the microfluidic device 10 includes a flow channel 12 including (a) an inlet 14, (b) an inlet section 16, extending along a first tangent, (c) an intermediate spiral section 18, including a plurality of loops 20, (d) an outlet section 22, extending along a second tangent, and (e) a 3D outlet system, generally designated by reference numeral 24. The flow channel 12 may be held in a housing 26, as shown, with the single inlet 14 fixed to a first sidewall 28 of the housing and the outlet 24 fixed to a second, opposite sidewall 30.

The flow channel 12 is rectangular in cross section and has a height H and a width W, where H>W. The flow channel 12 has a width W of between about 1 μm and about 250 μm and an aspect ratio of channel cross sectional area (H/W) of from about 1.5 to about 4.5. The intermediate spiral section 18 typically includes a plurality of half-circle loops forming from about 2 to about 10 complete loops with an increasing radius. Typically, the second innermost half-circle loop 38 has radius of about 0.2 mm to about 20 mm. Each succeeding half-circle loop going outwards increases in radius by from about 2.5 W and 5.0 W, where W is the width of the channel 12 as previously noted. The innermost half-circle loop 34 has a radius smaller than that of the second innermost half-circle loop 38. In some embodiments, the innermost half-circle loop 34 has a radius smaller than that of the second innermost half-circle loop 38.

The inlet 14 may comprise any structure of a type known in the art that is adapted to receive a suspension sample to be analyzed or processed. Upon passing through the inlet 14, the suspension sample moves under the influence of a positive pressure applied through the inlet 14 and/or a negative pressure/vacuum applied through the outlet 24 in a manner known in the art, through the inlet section 16 along a straight line or first tangent to the outermost loop 32 of the intermediate spiral section 18.

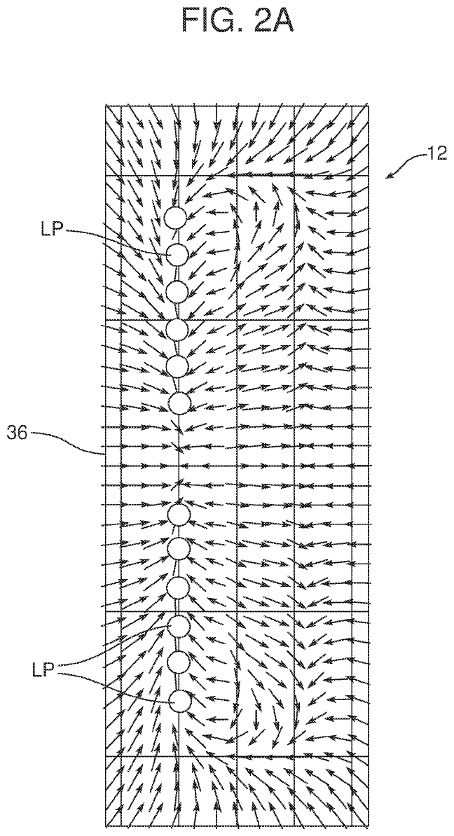

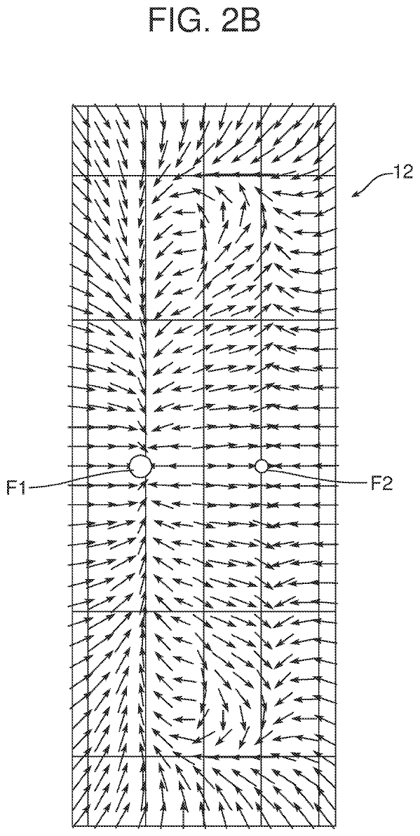

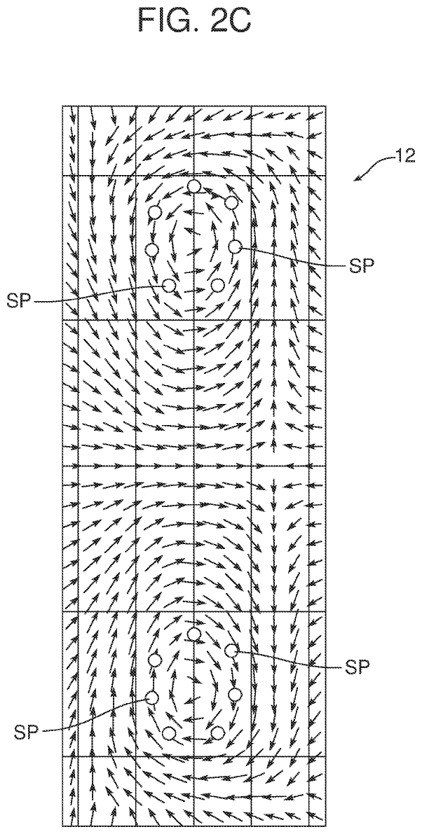

As the suspension sample moves through the loops 20 of the intermediate spiral section 18, large particles LP will first align along a virtual wall about 0.25 W away from the inner vertical sidewall 36 (see FIG. 2A) before reaching their stable focused points, F1 first, then to F2 if the Dean force is sufficiently high (see FIG. 2B), while small particles SP still circle in a helical pattern (see FIG. 2C). Such unique particle alignment and positioning are driven by the underlying vectors of the net force of the lifting, Dean and drag forces (see action arrows in FIGS. 2A-2C). Tuning the radius of the innermost half-circle loop 34 within a range that is smaller than that of the second innermost half-circle loop 38 will provide an increased Dean force in this last half-circle loop to push particles from position F1 toward F2, if not already at F2—the smaller this radius is, the higher the incremental Dean force becomes. Of the particles focused at point F1, smaller ones will be pushed over at a lower Dean force, or when the radius is larger; larger particles will be pushed over at a higher Dean force, or when the radius is smaller. Depending on the value of the radius of the innermost half-circle loop, these large particles can be forced to discharge either at the center right outlet or the center left outlet together, or separately by bracketing some through the center right outlet and the rest through the center left outlet. The straight section 22 provides a stabilizing mechanism to refocus these large particles to one of the two stable positions, either at F1 or F2, before being discharged at the corresponding outlets. For example, particles that have been pushed across the middle line but not yet reached F2 will be focused to F2, and particles that have not yet crossed the middle line will be focused back to F1.

After passing through the intermediate spiral section 18, the suspension sample passes through the outlet section 22 along a second straight line or tangent of the innermost half-circle loop 34 to the outlet 24 in a 3D layout. Note, the outlet section 22 ramps downward going under the loops 20 (offset from the plane of the loops) while also expanding in both transverse directions by about three times while maintaining the same aspect ratio. The inlet section 16 and the outlet section 22 extend in substantially opposite directions in the illustrated embodiment of FIG. 1.

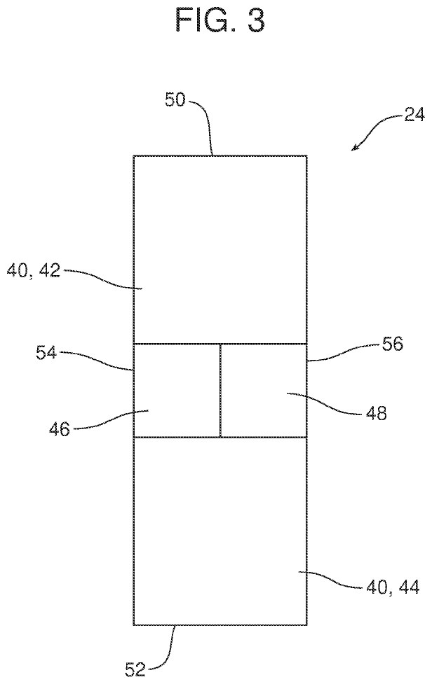

As best illustrated in FIG. 3, outlet 24 includes (a) two larger outlets 40 including an upper outlet 42 and a lower outlet 44, (b) a first or center left outlet 46 and (c) a second or center right outlet 48. As shown in FIG. 3, the upper outlet 42 borders the top wall 50 and the lower outlet 44 borders the bottom wall 52. Sandwiched in between, the center left outlet 46 borders the inner side wall 54, and the center right outlet 48 borders the outer sidewall 56.

In one possible embodiment of the microfluidic device 10, the upper and lower outlets 42 and 44 are both W wide and 0.4 H high, and the center left and right outlets 46 and 48 are both 0.5 W wide and 0.2 H high. The flow-rate in the flow channel 12 at the intermediate spiral section 18 to that at the upper outlet 42, the lower outlet 44, the center left outlet 46 and the center right outlet 48 is about 1:0.4:0.4:0.1:0.1. Advantageously, the relatively small cross sectional areas of the center left and right outlets 46, 48 tend to concentrate the particles being separated and collected through these outlets.

As should be appreciated from viewing FIGS. 2C and 3 together, the smaller particles SP, circling in a helical pattern in the suspension are positioned in the flow channel 12 to pass through the upper and lower outlets 42, 44. At the same time, as should be appreciated by viewing FIGS. 2B and 3 together, the larger particles at the focusing positions F1 and F2 in the suspension are positioned in the flow channel to pass through one of the two center outlets 46, 48.

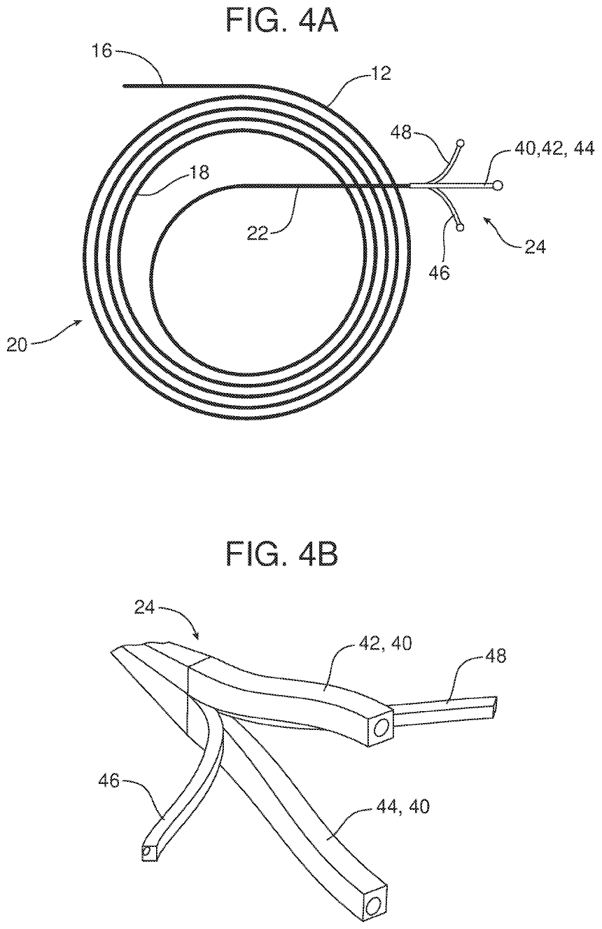

FIGS. 4A and 4B illustrate an embodiment of the device 10 adapted or tuned for separating particles of different sizes from a suspension of those particles wherein (a) 10 μm particles are discharged from the upper and lower center outlets 42, 44, (b) 15 μm particles are discharged from the center right outlet 48 and (c) 18-20 μm particles are discharged from the center left outlet 46. The flow channel 12 is rectangular in cross section with a height or length H of 247.5 μm and a width W of 90 μm. The outermost half-circle loop 32 has a radius of about 8.16 mm, the innermost half-circle loop has a radius of 4.8 mm. The half-circle loops between the outermost half-circle loop and the second innermost half-circle loop 38 decrease in radius by about 0.27 mm per half-circle loop. The overall length of the inlet section 16 is about 6 mm, the overall length of the intermediate spiral section 18 is about 215 mm and the overall length of the outlet section 22 is about 9 mm. The suspension is traveling through the flow channel 12 at a velocity of about 0.37 m/s. The suspension density is about 1000 kg/m³ and the dynamic viscosity is about 0.001 Pa-s or 0.01 Poise.

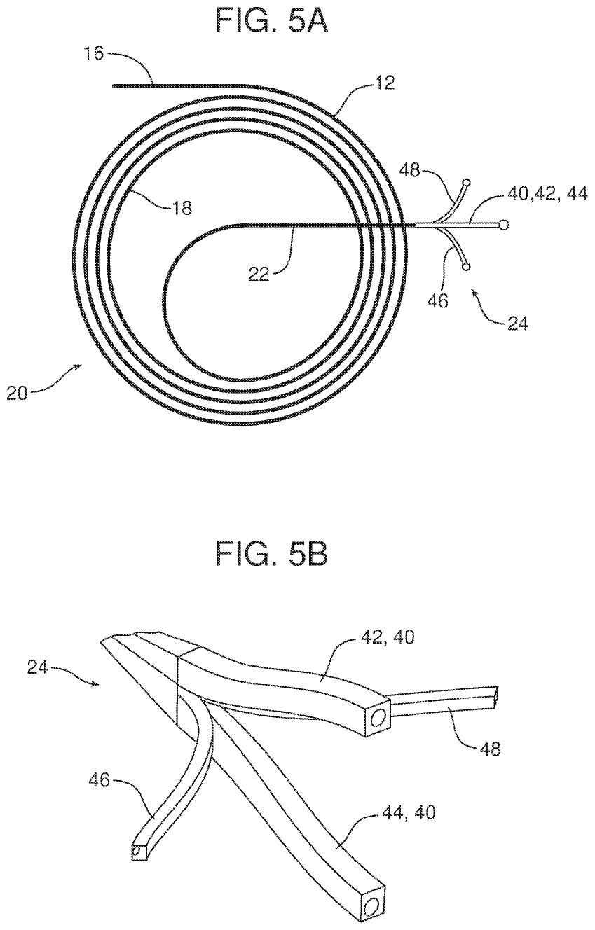

FIGS. 5A and 5B illustrate an embodiment of the device 10 adapted or tuned for separating particles of different sizes from a suspension of those particles wherein (a) 10 μm particles are discharged from the upper and lower center outlets 42, 44, (b) 15-18 μm particles are discharged from the center right outlet 48 and (c) 20 μm particles are discharged from the center left outlet 46. The flow channel 12 is rectangular in cross section with a height or length H of 247.5 μm and a width W of 90 μm. The outermost half-circle loop 32 has a radius of about 8.16 mm, the innermost half-circle loop has a radius of 4.05 mm. The half-circle loops between the outermost half-circle loop and the second innermost half-circle loop 38 decrease in radius by about 0.27 mm per half-circle loop. The overall length of the inlet section 16 is about 6 mm, the overall length of the intermediate spiral section 18 is about 213 mm and the overall length of the outlet section 22 is about 9 mm. The suspension is traveling through the flow channel 12 at a velocity of about 0.37 m/s. The suspension density is about 1000 kg/m³ and the dynamic viscosity is about 0.001 Pa-s or 0.01 Poise.

The microfluidic device may be made in a number of ways including, for example, by conventional lithographic methods, injection molding, or 3-D printing. With 3D printing, any UV curing polymer resins can be used if for sorting and separating conventional particles. For biological applications, the resins must be biocompatible to biological cells and tissues and also provide polymeric printing resolution in micron ranges.

The main ingredient of one resin useful in the 3-D printing of the microfluidic device 10 is a polymer known for its biocompatibility, namely, poly(ethylene glycol) diacrylate (PEGDA). Of several types of PEGDA, we have found that tetra(ethylene glycol) diacrylate copolymer (TEGDA; Sigma-Aldrich) gives good results in terms of UV curing time, printing resolution and features, and mechanical strength of the printed devices. To make the polymer UV sensitive, we added a photo-initiator, (1% w/w) phenylbis(2,4,6-trimethylbenzoyl) phosphine oxide (Irgacure 819; Sigma-Aldrich). To achieve fine printing features, a UV blocker, 2-nitrophenyl phenyl sulfide (NPS, Sigma-Aldrich), is added. To further strengthen the mechanical properties of printed devices 10, a crosslinker material, e.g, pentaerythritol tetra-acrylate, can be added to the polymer mixture in a desired amount depending on the target strength. To make the polymer, one first mixes a predetermined amount of monomer with 1% (w/w) photo-initiator and 0.75% (w/w) UV blocker thoroughly, then sonicates the mixture for 30-minute, finally, storing the photo-initiator-containing resins in amber glass bottles after mixing.

The UV-curing polymer, as formulated above may then be used to print numerous devices using a commercially available 3D printer, such as a Profluidics 385D, CADWorks3D, Canada. Microfluidic devices 10 with channel features less than 100 μm have been printed in this manner. These devices 10 have also been tested in cell transfection studies with great results.

The microfluidic devices 10 disclosed and described above may be used in a method of separating particles by size from a suspension sample. That method includes the steps of: (a) introducing the suspension sample into the inlet 14 of a flow channel 12; and (b) flowing the sample suspension through the flow channel from the inlet serially through (i) an inlet section 16, extending substantially along a first tangent, (ii) an intermediate spiral section 18, (iii) an outlet section 22, extending substantially along a second tangent, and (iv) an outlet 24 of the flow channel, including an center left outlet 46, a center right outlet 48, an upper outlet 42 and a lower outlet 44 whereby particles of a first size pass through the upper and lower outlets, particles of a second size pass through the center left outlet and particles of a third size pass through the center right outlet.

Advantageously, the method allows one to customize and tune the device 10 for the separation of different size particles through the center left outlet 46, the center right outlet 48, the upper outlet 42 and the lower outlet 44. Further, this is accomplished in a number of ways without requiring any real-time monitoring and tuning under a microscope. Those ways include, but are not necessarily limited to, one or more of the following:
(1) adjusting (a) the height H, (b) the width W or (c) the height H and the width W of the cross-section of the flow channel 12;
(2) adjusting a radius of the innermost loop 34 of the intermediate spiral section 18;
(3) adjusting radii of the plurality of loops 20 of the intermediate spiral section 18;
(4) adjusting an overall number of the plurality of loops 20 of the intermediate spiral section 18;
(5) adjusting an overall length of one or more of the inlet section 16, the intermediate spiral section 18 and the outlet section 22 of the flow channel 12;
(6) adjusting the flow velocity of the suspension through the flow channel 12; and
(7) adjusting the fluid properties (i.e. density and/or viscosity).

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a loop”, as used herein, may also refer to, and encompass, a plurality of loops.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified. Terms of approximation, such as the terms about, substantially, approximately, etc., as used herein, refers to ±10% of the stated numerical value.

Although the microfluidic device 10 and method of this disclosure have been illustratively described and presented by way of specific exemplary embodiments, and examples thereof, it is evident that many alternatives, modifications, or/and variations, thereof, will be apparent to those skilled in the art. For example, the inlet 14 and outlet 24 may be reversed; that is, the inlet may be connected to the innermost loop 34 and the outlet may be connected to the outermost loop 32. Accordingly, it is intended that all such alternatives, modifications, or/and variations, fall within the spirit of, and are encompassed by, the broad scope of the appended claims.

What is claimed:

1. A three-dimensional (3D) microfluidic device, comprising:
a flow channel including (a) an inlet, (b) an inlet section, extending along a first tangent, (c) an intermediate spiral section, (d) an outlet section, extending along a second tangent, and (e) a 3D outlet system including a plurality of outlets.

2. The microfluidic device of claim 1, wherein the flow channel has a rectangular cross section having a height H and a width W, where H>W.

3. The microfluidic device of claim 2, wherein the flow channel includes a top wall, a bottom wall, a first sidewall and a second sidewall.

4. The microfluidic device of claim 3, wherein the plurality of outlets includes (a) an upper outlet, bordering the top wall, (b) a lower outlet, bordering the bottom wall, (c) a first center outlet, between the upper outlet and the lower outlet and bordering the first sidewall, and (d) a second center outlet between the upper outlet and the lower outlet and bordering the second sidewall.

5. The microfluidic device of claim 2, wherein the flow channel has a width of between about 1 μm and about 250 μm and an aspect ratio of channel cross sectional area (H/W) of from about 1.5 to about 4.5.

6. The microfluidic device of claim 5, including about 2 to about 10 complete loops.

7. The microfluidic device of claim 6, wherein the intermediate spiral section includes a plurality of consecutive half-circle loops wherein the second innermost half-circle loop has a radius that is about 0.2 mm to about to about 20 mm.

8. The microfluidic device of claim 7, wherein the second innermost half-circle loop and subsequent half-circle loops going outwards incrementally increase in radius by from about 2.5 W to about 5.0 W.

9. The microfluidic device of claim 8, wherein the innermost half-circle loop has a radius smaller than that of the second innermost half-circle loop.

10. The microfluidic device of claim 4 wherein the flow rate in the flow channel at the intermediate spiral section to that at the upper outlet, the lower outlet, the center left outlet and the center right outlet is about 1:0.4:0.4:0.1:0.1.

11. The microfluidic device of claim 5, wherein the upper outlet is W wide and 0.4 H high and the lower outlet is W wide and 0.4 H high, the first center outlet is 0.5 W wide and 0.2 H high and the second center outlet is 0.5 W wide and 0.2 H high.

12. A method of separating particles by size from a suspension sample, comprising:
introducing the suspension sample into the inlet of a flow channel; and
flowing the sample suspension through the flow channel from the inlet serially through (a) an inlet section, extending along a first tangent, (b) an intermediate spiral section, (c) an outlet section, extending along a second tangent, and (d) a 3D outlet system including a first center outlet, a second center outlet, an upper outlet and a lower outlet wherein particles of a first size pass through the upper and lower outlets, particles of a second size pass through the first center outlet and particles of a third size pass through the second center outlet.

13. The method of claim 12, further including using a flow channel having a rectangular cross section with a height H and a width W, wherein H>W and adjusting (a) the height H, (b) the width W or (c) the height H and the width W of the flow channel to tune separation of different size particles through the first center outlet, the second center outlet, the upper outlet and the lower outlet.

14. The method of claim 12, further including adjusting a radius of the innermost loop of the intermediate spiral section to tune separation of different size particles through the first center outlet, the second center outlet, the upper outlet and the lower outlet.

15. The method of claim 12, further including adjusting radii of a plurality of loops of the intermediate spiral section to tune separation of different size particles through the first center outlet, the second center outlet, the upper outlet and the lower outlet.

16. The method of claim 12, further including adjusting an overall number of a plurality of loops of the intermediate spiral section to tune separation of different size particles through the first left outlet, the second center outlet, the upper outlet and the lower outlet.

17. The method of claim 12, further including adjusting overall length of one or more of the inlet section, the intermediate spiral section and the outlet section of the flow channel to tune separation of different size particles through the first center outlet, the second center outlet, the upper outlet and the lower outlet.

18. The method of claim 12, further including adjusting at least one of the flow velocity of the suspension through the flow channel, the viscosity of the suspension and the density of the suspension to tune separation of different size particles through the first center outlet, the second center outlet, the upper outlet and the lower outlet.

19. A microfluidic device, comprising:
a flow channel including (a) an inlet, (b) an inlet section, extending along a first tangent, (c) an intermediate spiral section, (d) an outlet section, extending along a second tangent, and (e) an 3D outlet system including an upper outlet, a lower outlet, a center left outlet and a center right outlet whereby particles in a suspension passing through the flow channel are separated for recovery of different size particles through the (a) upper and lower outlets, (b) the center left outlet and (c) the center right outlet.

20. The microfluidic device of claim 19, wherein a flow rate in the flow channel at the intermediate spiral section to that at the upper outlet, the lower outlet, the center left outlet and the center right outlet is about 1:0.4:0.4:0.1:0.1.
